(19) United States
(12) Patent Application Publication
(10) Pub. No.: US 2005/0099399 A1
(43) Pub. Date: May 12, 2005

(54) Pen-based input and data storage device

(76) Inventor: Lun-Chuan Chang, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/704,055

(22) Filed: Nov. 7, 2003

(51) Int. Cl. G09G 5/00

(52) U.S. Cl. 345/173

(57) ABSTRACT

A pen-based input and data storage device is proposed, which is designed for use with an information platform of the type having a touch screen for pen-based input functionality, such as a tablet computer or a PDA (Personal Digital Assistant), for the purpose of allowing the user to use it either as a pointing pen for pen-based data input via the touch screen to the information platform, or as an external data storage unit for the information platform. The proposed pen-based input and data storage device is advantageous to use in that it allows the user to conveniently transfer data from tablet computer or PDA to another information platform without having to use cables or infrared transmitters, which makes it more conveniently and cost-effectively to use than prior art.

### BACKGROUND OF THE INVENTION

1. Field of the Invention

This invention relates to computer peripheral technology, and more particularly, to a pen-based input and data storage device, which is designed for use with an information platform of the type having a touch screen for pen-based input functionality, such as a tablet computer or a PDA (Personal Digital Assistant) device, for the purpose of allowing the user to use the pen-based input and data storage device of the invention both as a pointing pen for pen-based data input via the touch screen to the information platform and as an external data storage unit for the information platform.

2. Description of Related Art

Touch screen is a type of data input means that is typically equipped on portable computers, such as tablet computers, PDA (Personal Digital Assistant) devices, and so on, for the user to use a pointing pen to touch or write on the touch screen to input commands or handwritten data into the tablet computer or PDA. For example, when the user wants to select a menu or option, the user needs just to point the pen at corresponding icons on the touch screen; and when the user wants to input text data to the tablet computer or PDA, the user needs just to use the pen to write on the touch screen, and the tablet computer or PDA will use handwriting recognition software to recognize the handwritten strokes on the touch screen and convert them into binary characters for further processing in the tablet computer or PDA.

When the user wants to transfer data stored on his/her tablet computer or PDA to another information platform, such as desktop computer or notebook computer, however, the user needs to either use a cable to interconnect his/her tablet computer or PDA with the other information platform for wired transfer of data, or use an infrared transmitter installed on the tablet computer or PDA to transmit data wirelessly to the other information platform.

One drawback to the forgoing method of data transfer, however, is that it requires the user to carry an additional cable on the road or install infrared transmitter as an addition peripheral device on the user's tablet computer or PDA, which is inconvenient and costly to utilize.

### SUMMARY OF THE INVENTION

It is therefore an objective of this invention to provide a pen-based input and data storage device which allows the user to conveniently transfer data from tablet computer or PDA to desktop computer without having to use cables or infrared transmitters.

It is another objective of this invention to provide a pen-based input and data storage device which allows the user to use both a pointing pen and an external data storage unit for tablet computer or PDA.

The pen-based input and data storage device according to the invention is designed for use with an information platform of the type having a touch screen for pen-based input functionality, such as a tablet computer or a PDA (Personal Digital Assistant) device, for the purpose of allowing the user to use the pen-based input and data storage device of the invention both as a pointing pen for pen-based data input via the touch screen to the information platform and as an external data storage unit for the information platform.

The pen-based input and data storage device according to the invention comprises: (a) a handle portion having a front end and a rear end; (b) a pointer portion, which is linked to the front end of the handle portion, and which serves as a pen tip for user-manipulated data input via the touch screen to the information platform; (c) a data storage unit, which is mounted on the rear end of the handle portion to serve as an external data storage unit for the information platform; and (d) a connecting port, which is fixed and electrically connected to the data storage unit for use to couple the data storage unit to the information platform for the data storage unit to serve as an external data storage unit for the information platform.

The pen-based input and data storage device according to the invention allows the user to use it either as a pointing pen for pen-based data input via the touch screen to the information platform, or as an external data storage unit for the information platform. The pen-based input and data storage device of the invention is advantageous to use in that it allows the user to conveniently transfer data from tablet computer or PDA to another information platform without having to use cables or infrared transmitters. The invention is therefore more conveniently and cost-effectively to use than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an instance of the pen-based input and data storage device of the invention being coupled to an information platform (PDA) for use as an external data storage unit;

FIG. 2 is a schematic diagram showing an instance of the pen-based input and data storage device of the invention being used as a pointing pen for pen-based data input via an touch screen to an information platform (PDA); and

FIG. 3 is a schematic diagram showing the architecture of the pen-based input and data storage device according to the invention.

### DETAILED DESCRIPTION OF PREFERRED EMBODIMENTS

A preferred embodiment of the pen-based input and data storage device according to the invention is disclosed in full details in the following with reference to the accompanying drawings.

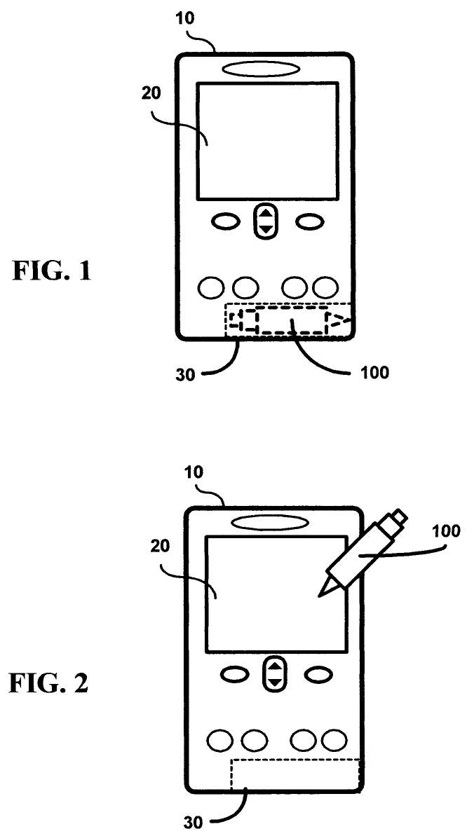

Referring first to FIG. 1 and FIG. 2, the pen-based input and data storage device of the invention 100 is designed for use with an information platform 10 of the type having a touch screen 20 for pen-based input functionality, such as a tablet computer or a PDA (Personal Digital Assistant), for the purpose of allowing the user to use the pen-based input and data storage device of the invention 100 both as a pointing pen for pen-based data input via the touch screen 20 to the information platform 10 and as an external data storage unit for the information platform 10. In practical implementation, for instance, as illustrated in FIG. 1, the pen-based input and data storage device of the invention 100 is housed in a slot 30 in the casing of the information platform 10 to serve as an external data storage unit for the information platform 10; and then as illustrated in FIG. 2, when the user wants to input data via the touch screen 20 to the information platform 10, the user can take out the pen-based input and data storage device of the invention 100 from the slot 30 and then use the pen-based input and data storage device of the invention 100 as a pointing pen for data input via the touch screen 20 to the information platform 10.

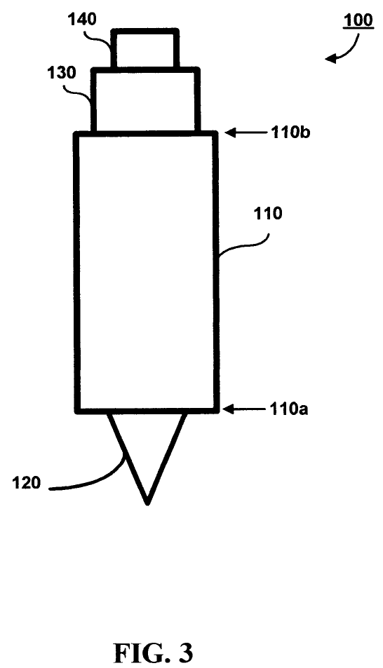

FIG. 3 is a schematic diagram showing the architecture of the pen-based input and data storage device of the invention 100. As shown, the pen-based input and data storage device of the invention 100 comprises: (a) a handle portion 110; (b) a pointer portion 120; (c) a data storage unit 130; and (d) a connecting port 140.

The handle portion 110 is an elongated body, preferably an elongated cylindrical body, that is designed for handhold by the user, and which has a front end 110a and a rear end 110b, wherein the front end 110a is linked to the pointer portion 120 while the rear end 110b is mounted with the data storage unit 130 and the connecting port 140.

The pointer portion 120 is an outwardly tapered structure to provide a sharp tip, and which is linked to the front end 110a of the handle portion 110 to serve as a pen tip for the user to perform pen-based data input via the touch screen 20 to the information platform 10. There are various ways for linking the pointer portion 120 to the front end 110a of the handle portion 110, including, for example, by integrally linking the pointer portion 120 to the front end 110a of the handle portion 110 (i.e., integrally formed), or by using a collapsible mechanism to allow the pointer portion 120 to be collapsible to the inside of the handle portion 110 to reduce the overall body length when not in use, or by using a foldable mechanism to allow the pointer portion 120 to be folded down on the front end 110a of the handle portion 110 to reduce the overall body length when not in use. Beside these embodiments, various other ways to link the pointer portion 120 to the front end 110a of the handle portion 110 are possible.

The data storage unit 130 is, for example, a flash memory module, which is mounted on the rear end 110b of the handle portion 110 (or housed on a hollowed inside of the handle portion 110) for use to serve as an external data storage unit for the information platform 10. Moreover, the data storage unit 130 can be a replaceable type of memory module that allows the user to replace memory modules of various types and capacities as needed.

The connecting port 140 is, for example, a USB (Universal Serial Bus) compliant connecting port, which is fixed and electrically connected to the data storage unit 130 and mounted on the rear end 110b of the handle portion 110 for use to electrically connect the data storage unit 130 to a corresponding connecting port (not shown) on the information platform 10 for the data storage unit 130 to serve as an external data storage unit for the information platform 10.

In actual application, the pen-based input and data storage device of the invention 100 allows the user to use it either as a pointing pen for pen-based data input via the touch screen 20 to the information platform 10 (as illustrated in FIG. 2) or as an external data storage unit for the information platform 10 (as illustrated in FIG. 1).

As shown in FIG. 1, when the user wants to use the pen-based input and data storage device of the invention 100 as an external data storage unit for the information platform 10, the user needs just to couple the USB connecting port 140 on the pen-based input and data storage device of the invention 100 to a corresponding USB connecting port (not shown) on the information platform 10. This allows the information platform 10 to read data from or write data into the data storage unit 130 via the connecting port 140. Further, the user can unplug the pen-based input and data storage device of the invention 100 from the information platform 10 and plug it to a corresponding USB connecting port on another computer unit (not shown), such as a desktop computer or a notebook computer for convenient data transfer from the information platform 10 to the desktop computer or notebook computer.

As further shown in FIG. 2, when the user wants to input data via the touch screen 20 to the information platform 10, the user needs just to hold the handle portion 110 by hand and then use the pointer portion 120 to select commands or menu options on the touch screen 20 to operate the information platform 10, or use the pointer portion 120 to write on the touch screen 20 for the information platform 10 to recognize user's handwritten strokes by using handwriting recognition software.

In conclusion, the invention provides a pen-based input and data storage device, which is designed for use with an information platform of the type having a touch screen for pen-based input functionality, for the purpose of allowing the user to use the pen-based input and data storage device of the invention either as a pointing pen for pen-based data input via the touch screen to the information platform, or as an external data storage unit for the information platform. The pen-based input and data storage device of the invention is advantageous to use in that it allows the user to conveniently transfer data from tablet computer or PDA to another information platform without having to use cables or infrared transmitters. The invention is therefore more conveniently and cost-effectively to use than prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A pen-based input and data storage device for an information platform of the type having a touch screen, which comprises:
a handle portion having a front end and a rear end;
a pointer portion, which is linked to the front end of the handle portion, and which serves as a pen tip for user-manipulated data input via the touch screen to the information platform;
a data storage unit, which is mounted on the rear end of the handle portion to serve as an external data storage unit for the information platform; and
a connecting port, which is fixed and electrically connected to the data storage unit for use to couple the data storage unit to the information platform for the data storage unit to serve as an external data storage unit for the information platform.

2. The pen-based input and data storage device of claim 1, wherein the information platform is a PDA (Personal Digital Assistant) device.

3. The pen-based input and data storage device of claim 1, wherein the information platform is a tablet computer.

4. The pen-based input and data storage device of claim 1, wherein the pointer portion is fixedly linked to the front end of the handle portion.

5. The pen-based input and data storage device of claim 1, wherein the pointer portion is collapsible to the inside of the handle portion.

6. The pen-based input and data storage device of claim 1, wherein the pointer portion is foldable on the front end of the handle portion.

7. The pen-based input and data storage device of claim 1, wherein the connecting port is a USB (Universal Serial Bus) compliant connecting port.

8. The pen-based input and data storage device of claim 1, wherein the data storage unit is a flash memory module.

9. The pen-based input and data storage device of claim 1, wherein the data storage unit is a replaceable memory module.
